(19) United States
(12) Patent Application Publication
(10) Pub. No.: US 2009/0096609 A1
(43) Pub. Date: Apr. 16, 2009

(54) Packaging material with radio frequency identification tag and manufacturing method thereof

(75) Inventors: Chi-Fang Huang, Taipei City (TW); Yung-Shun Chen, Chung Li City (TW)

Correspondence Address: BACON & THOMAS, PLLC, 625 SLATERS LANE, FOURTH FLOOR, ALEXANDRIA, VA, 22314-1176, US

(73) Assignee: TAIWAN LAMINATION INDUSTRIES INC., Chung Li City (TW)

(21) Appl. No.: 12/232,497

(22) Filed: Sep. 18, 2008

(30) Foreign Application Priority Data
Oct. 15, 2007 (TW) 096138433

(51) Int. Cl. G08B 13/14; B32B 37/02

(52) U.S. Cl. 340/572.1; 156/277

(57) ABSTRACT

The present invention discloses a packaging material with a RFID tag, and the packaging material includes a surface material, a protecting layer printed on an internal side of the surface material, a conducting layer formed on the protecting layer to constitute a pattern of a transceiver antenna, a chip coupled to a feedback terminal of the transceiver antenna to form the RFID tag, a substrate and a coupling agent for combining an internal side of the surface material with an internal side of the substrate. The invention also discloses a method of manufacturing the packaging material with the RFID tag.

### FIELD OF THE INVENTION

The present invention relates to a packaging material, and more particularly to a packaging material with a radio frequency identification (RFID) tag and its manufacturing method.

### BACKGROUND OF THE INVENTION

Radio frequency identification (RFID) technology is a communication technology related with a RFID tag, so that an identification system can identify a specific target through a radio signal and can read and write related data in the specific target without requiring a mechanical or optical contact between the identification system and the specific target at all. In general, the RFID tag is composed of a transceiver antenna and a chip, and the chip is connected to a feedback terminal of the transceiver antenna. The RFID technology is mainly divided into the following three types by its properties:
(1) Passive Type: Passive RFID tag has no internal power supply, and its chip is driven by an electromagnetic wave received by the transceiver antenna, and the electromagnetic wave is transmitted from a RFID reader of an identification system. If the RFID tag receives sufficient signals, the data stored in the chip will be transmitted to the reader. In general, a function of the transceiver antenna is to receive the electromagnetic wave received by the reader to drive the chip, and another function of the transceiver antenna is to return a signal through the RFID tag that requires a switch of impedance of the transceiver antenna to generate data in the form of 0 and 1. The RFID tag comes with a low price and requires no power supply, and thus the passive RFID tag becomes the mainstream of the RFID tag.
(2) Semi-passive Type: Semi-passive RFID tag is similar to passive RFID tag, except it has a small battery with an electric power sufficient to drive the chip, so that when the chip is at an operating state, the transceiver antenna no longer needs to receive the electromagnetic wave, but simply carries out the function of returning a signal. Compared with the passive RFID tag, the semi-passive RFID tag has faster and better speed and efficiency, but the semi-passive RFID tag incurs a higher cost and gives a shorter life of use.
(3) Active Type: Unlike the passive and semi-passive RFID tags, the active RFID tag has an internal power supply device for supplying power to the chip to generate an external signal, and thus the active RFID tag generally provides a longer reading distance and a larger memory capacity for storing additional information transmitted from the reader.

The present invention mainly focuses on the passive RFID tag which is the mainstream of the RFID tag for the illustration, and this type of RFID tag has become a future star of the product identification technology in different industries, since the passive RFID has the following advantages:
(1) Storing more data;
(2) Having a longer communication distance;
(3) Difficult to duplicate;
(4) Having a high endurance to environmental changes; and
(5) Capable of reading several RFID tags at the same time.

However, the major drawback of the passive RFID tag is its high manufacturing cost. At the beginning of 2005, the price of each RFID tag was still approximately 30 Euro cents, but the production cost drops significant through present mass production technology. For a large quantity (over one billion pieces) of the mass produced RFID tags, the price will drop below 10 Euro cents per piece in 2008.

The application area of the RFID tag is very extensive, and its major determining factor depends on the economic benefits of the related area, and the applications of the RFID tag include but not limited to the following:
(1) Dollar bill and product anti-counterfeiting technique;
(2) Identity card and pass (including ticket);
(3) Electronic toll collection such as Octopus card in Hong Kong and Easycard in Taiwan;
(4) Livestock or wild animal identification; and
(5) Patient identification and electronic anamnesis.

In addition, the application of the RFID tag has been extended to logistics management for a schedule control of all nodes in a supply chain at different stages such as the product design, material planning, production, transportation, warehouse storage, distribution, marketing and sales of semi-finished goods and finished goods, and even goods return and after-sales service in order to control related information including product type, manufacturer, manufacturing time, country of origin, color, dimensions, quantity, port of destination and receiver of a product precisely.

With reference to FIG. 1 for an extensively used RFID tag, a transceiver antenna 20 and a chip 30 of the RFID tag 10 are formed on a polyimide substrate 40 by attaching a copper clad 41 onto a side of the polyimide substrate to form a flexible copper clad laminate, and then etching a required transceiver antenna 20 on the copper clad 41 by an etching technology, and connecting the chip 30 to a feedback terminal 21 of the transceiver antenna 20 to manufacture a RFID tag 10. The RFID tag of this sort not only incurs a complicated manufacturing process and a high cost, but also requires an additional manufacturing process to attach the RFID tag onto the product or its packaging bag when the RFID tag is applied to the logistic management of the aforementioned products. The additional manufacturing process increases the manufacturing cost of the product, and also damages the external look and design of the packaging bag. The RFID tag may even be damaged or peeled off easily during the manufacturing and transportation processes of the produce if the RFID tag is not attached properly.

Therefore, it is an important subject for manufacturers to manufacture a RFID tag onto a product or a packaging bag during the process of manufacturing the product or packaging bag in order to reduce the manufacturing cost of the RFID tag significantly and produce various types of products with an installed RFID tag without increasing the manufacturing cost or ruining the external look and design of the product or the packaging bag.

### SUMMARY OF THE INVENTION

In view of the shortcomings of the conventional RFID tag requiring a complicated manufacturing process, incurring a high cost and adding an additional manufacturing process to attach the RFID tag onto the product or the packaging bag that further increases the manufacturing cost and ruin the external look and design of the product, the inventor of the present invention based on years of experience in the related industry to conduct extensive researches and experiments, and finally developed a packaging material with a RFID tag in accordance with the present invention to overcome the shortcomings of the prior art.

Therefore, it is a primary objective of the present invention to provide a method of manufacturing a packaging material with a RFID tag, and the method is applied to a packaging material that comprises a surface material and a substrate. In the method, an ink layer (such as an ink used for forming various decorative or advertising patterns or images) is printed on an internal side of the surface material by a gravure printing technique; a protecting layer (such as an anchor coating agent used for electroplating) is printed on the ink layer; a dissolving layer composed of a water soluble material (such as a water soluble resin) is printed on the protecting layer; a pattern without the printed water soluble material is formed in a predetermined area of the dissolving layer; and a conducting layer (such as a conducting layer containing aluminum or copper) is coated or vaporized onto the internal side. After the conducting layer is formed on the internal side of the surface material, the internal side of the surface material is rinsed by an aqueous solution to permeate the aqueous solution into the dissolving layer and dissolve the water soluble material, such that the conducting layer covered onto the water soluble material and the protecting layer on the water soluble material and the conducting layer covered onto a pattern without the printed water soluble material in the predetermined area are peeled off to produce a pattern required by a transceiver antenna. A chip is connected to a feedback terminal of the transceiver antenna to form a RFID tag on the internal side of the surface material, and a coupling agent is used to combine an internal side of the surface material with an internal side of the substrate to form a packaging material with a printed decorative pattern and a RFID tag.

Another objective of the present invention is to print an ink layer on an internal side of the surface material by a gravure printing technique, and print a protecting layer (such as an anchor coating agent for electroplating) on an external side of the surface material, and print a dissolving layer composed of a water soluble material on the protecting layer, and form a pattern without the printed water soluble material in a predetermined area of the dissolving layer, use a coupling agent to combine the internal side of the surface material and the internal side of a substrate, and form a conducting layer on the external side of the surface material by coating or evaporation. After the conducting layer is formed on the external side of the surface material, an aqueous solution is used for rinsing the external side of the surface material to permeate the aqueous solution into the dissolving layer and dissolve the water soluble material, such that the water soluble material and the conducting layer covered on the water soluble material are peeled off from the protecting layer, such that the conducting layer is covered onto the pattern without the printed water soluble material in the predetermined area to constitute a pattern required by a transceiver antenna. A chip is coupled to a feedback terminal of the transceiver antenna to form a RFID tag on the external side of the surface material to produce a packaging material with a printed decorative pattern and a RFID tag.

Another objective of the present invention is to provide a packaging material manufactured by the aforementioned method to produce various products (such as packaging bags) that require a RFID tag.

A further objective of the present invention is to provide the packaging material further comprising a functional material, and both sides of the functional material are coupled to the internal side of the surface material and the internal side of the substrate by a coupling agent, and the functional material is provided for improving the structural strength, air-tightness or water resistance of the packaging material according to the actual requirements.

### BRIEF DESCRIPTION OF THE DRAWINGS

FIG. 1 is a schematic view of a manufacturing process of a conventional RFID tag;

FIG. 2 is a schematic view of a composition structure of a conventional packaging material;

FIG. 3 is a flow chart of manufacturing a package material with a RFID tag in accordance with the present invention;

FIG. 4 is a cross-sectional view of an ink layer, a protecting layer and a dissolving layer printed sequentially on an internal side of a surface material in accordance with the present invention;

FIG. 5 is a cross-sectional view of a conducting layer formed on a surface of dissolving layer and a predetermined area in accordance with the present invention;

FIG. 6 is a cross-sectional view of a transceiver antenna pattern formed on an internal side of a surface material in accordance with the present invention;

FIG. 7 is a cross-sectional view of a RFID tag formed on an internal side of a surface material in accordance with the present invention;

FIG. 8 is a cross-sectional view of a packaging material in accordance with a first preferred embodiment of the present invention;

FIG. 9 is a cross-sectional view of a packaging material in accordance with a second preferred embodiment of the present invention;

FIG. 10 is a flow chart of a third preferred embodiment of the present invention;

FIG. 11 is a cross-sectional view of printing an ink layer, a protecting layer and a dissolving layer on inner and external sides of a surface material respectively in accordance with the present invention;

FIG. 12 is a cross-sectional view of forming a conducting layer on surfaces of an ink layer, a water soluble material and other remaining areas in accordance with the present invention;

FIG. 13 is a cross-sectional view of forming a conducting layer on surfaces of a dissolving layer and a predetermined area in accordance with the present invention; and

FIG. 14 is a cross-sectional view of forming a RFID tag on an external side of a surface material in accordance with the present invention.

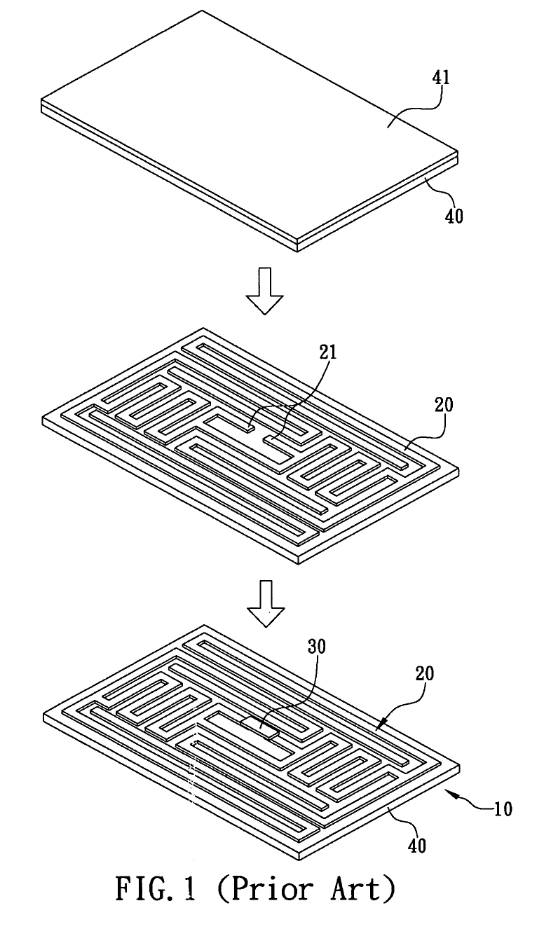

### DETAILED DESCRIPTION OF THE PREFERRED EMBODIMENTS

The present invention relates to a packaging material with a radio frequency identification (RFID) tag and its manufacturing method, and the method is applied to a packaging material.

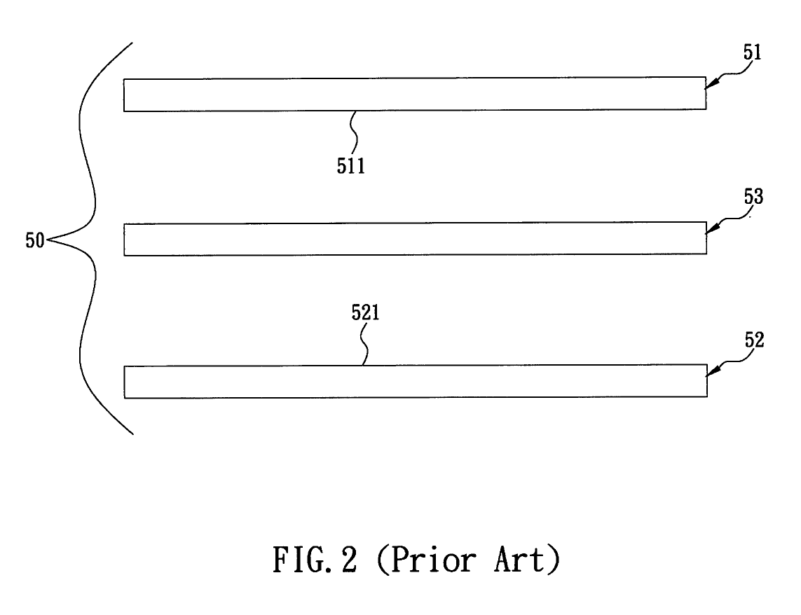

In FIG. 2, the packaging material 50 is a thin film substrate made of a plastic material that is generally used for manufacturing various types of products (such as packaging bags). The packaging material 50 comprises a surface material 51, a substrate 52 and a coupling agent 53, wherein the surface material 51 is a transparent or oblique thin film made of a plastic material such as oriented polypropylene (OPP) or poly ethylene terephthalate (PET), and the substrate 52 is a transparent or oblique thin film made of polyethylene (PE) or polypropylene (PP), and the coupling agent 53 refers to a layer of adhesive glue used for combining the surface material 51 and the substrate 52 to form a packaging material 50 in accordance with the present invention.

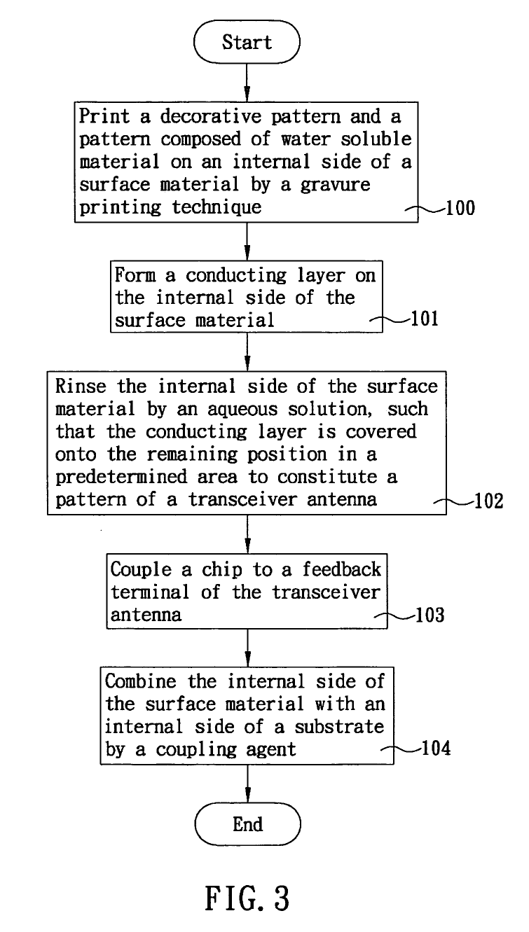

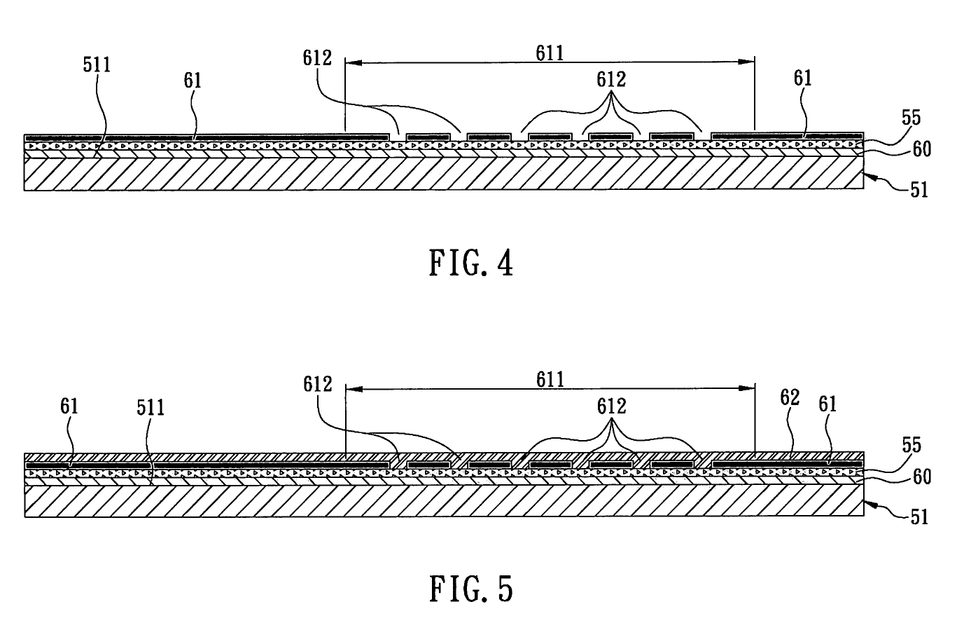

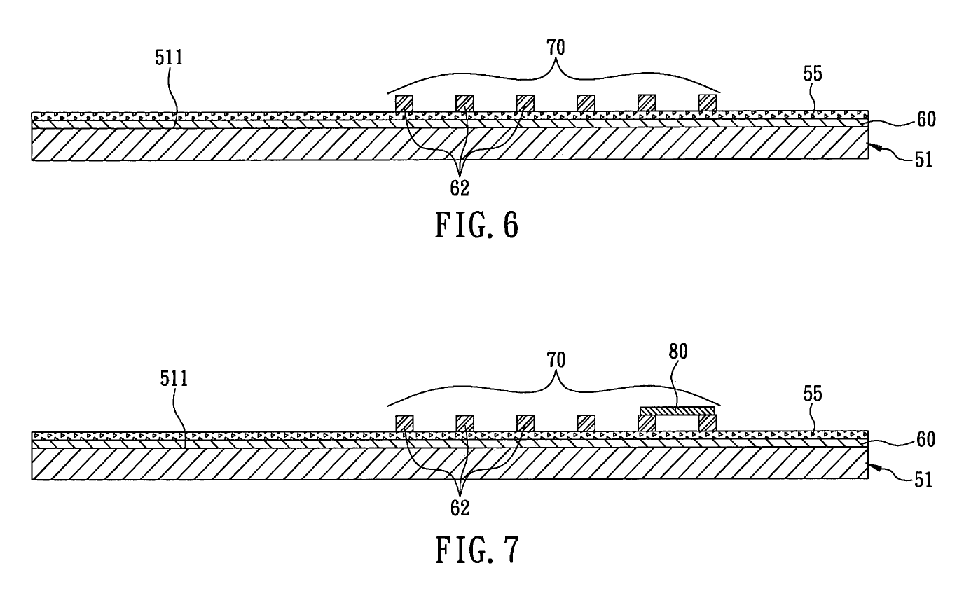

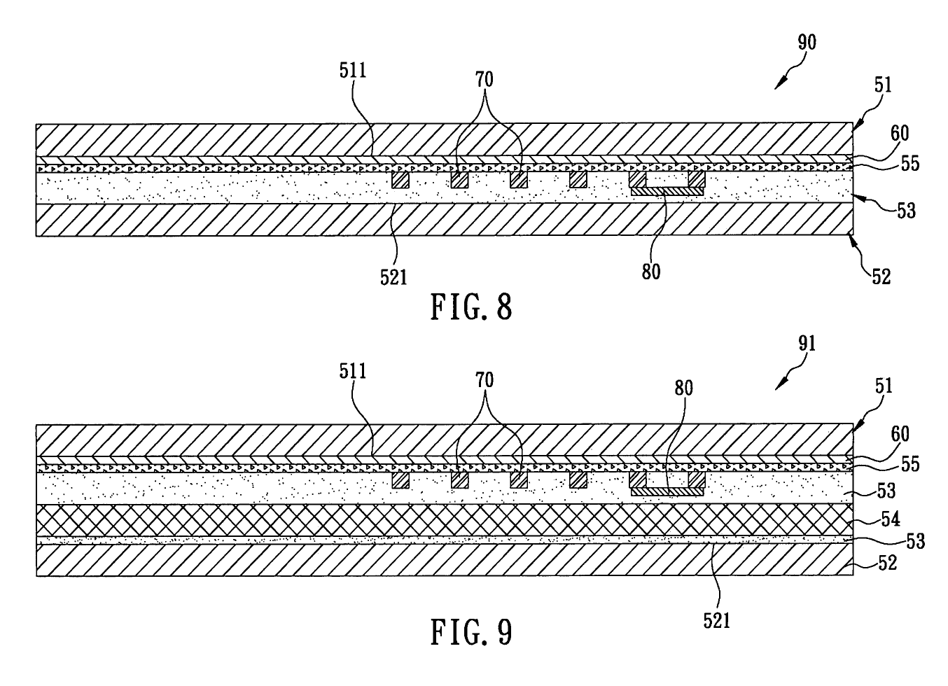

In FIG. 3, a method in accordance with a preferred embodiment of the present invention comprises the steps of:
Step (100): printing an ink layer 60 on an internal side 511 of the surface material 51 by a gravure printing technique as shown in FIG. 4 to form a decorative pattern (such as various decorative, descriptive or advertising texts, symbols or images), printing a protecting layer 55 (such as an anchor coating agent) on the ink layer 60, printing a dissolving layer 61 composed of a water soluble material (such as a water soluble resin) on the protecting layer 55, and forming a pattern 612 without the printed water soluble material in a predetermined area 611 of the dissolving layer 61;
Step (101): forming a conducting layer 62 on the internal side 511 which is the dissolving layer 61 and a surface of the predetermined area 611 by coating, sputtering or evaporation as shown in FIG. 5, wherein the conducting layer 62 can be made of a conducting material such as aluminum or copper, and it is noteworthy to point out that the aforementioned protecting layer 55 has a higher heat-resisting temperature than the heat-resisting temperature of the surface material 51 or the ink layer 60, and thus the protecting layer 55 is coated onto the ink layer 60 to protect the surface material 51 or the ink layer 60 from being deteriorated (or blackened) by the high temperature of the sputtering or evaporation;
Step (102): rinsing the internal side 511 of the surface material 51 by an aqueous solution after forming the conducting layer 62 on the internal side of the surface material 51, so as to permeate the aqueous solution into the dissolving layer 61, dissolve the water soluble material, peel off the water soluble material and the conducting layer 62 coated on the water soluble material from the protecting layer 55, and form a pattern of a transceiver antenna 70 as shown in FIG. 6 onto the pattern 612 without the water soluble material covered on the conducting layer 62 and in the predetermined area 611;
Step (103): coupling a chip 80 to a feedback terminal of the transceiver antenna 70 as shown in FIG. 7 to form a RFID tag on an internal side 511 of the surface material 51; and
Step (104): using a coupling agent 53 to couple the internal side 511 of the surface material 51 with an internal side 521 of the substrate 52 as shown in FIG. 2 to form a packaging material 90 with a printed decorative pattern and a RFID tag as shown in FIG. 8.

Therefore, the present invention allows manufacturers to manufacture a RFID tag with the packaging material 90 when the decorative pattern are printed onto the packaging material 90, and thus the invention not only simplifies the manufacturing process and lowers the manufacturing cost, but also prevents the external look and design of a product or a packaging bag from being ruined since the RFID tag is wrapped around the packaging material 90. In addition, the RFID tag is protected by the packaging material 90, so that the RFID tag will not be damaged easily during the manufacturing and transportation processes of the product. The packaging material can be used by designers and manufacturers for producing various products such as a packaging bag that requires a RFID tag, and manufacturers can use the data or information provided by the RFID tag of the product to monitor and manage all nodes of a supply chain for the production, transportation, warehouse storage, distribution, selling, goods return and after-sales service in a logistics management process to effectively enhance the efficiency of the logistics management and reduce the cost of channel management.

It is noteworthy to point out that the aforementioned packaging material 90 is just an embodiment provided for illustrating the present invention, but the invention is not limited to such embodiment only. In another embodiment of the present invention, a functional material 54 is added between the internal side 511 of the surface material 51 and the internal side 521 of the substrate 52 according to the actual requirements as shown in FIG. 9, and the functional material 54 is a thin film made of a lylon material or any other appropriate plastic material for improving the structural strength, air-tightness or water resistance of the packaging material 91. In addition, an ink layer 60, a protecting layer 55, a dissolving layer 61 and a conducting layer 62 are coated sequentially onto the internal side 511 of the surface material 51, and a pattern of a transceiver antenna 70 is formed on the protecting layer 55 according to the aforementioned procedure, and a chip 80 is coupled to a feedback terminal of the transceiver antenna 70 to form a RFID tag on the internal side 511 of the surface material 51. After the RFID tag is formed on the internal side 511 of the surface material 51, a coupling agent 53 is coated between the functional material 54 and the internal side 511 of the surface material 51, and between the functional material 54 and the internal side 521 of the substrate 52 respectively to combine the aforementioned three elements as a whole and form a packaging material 91 with a printed decorative pattern and a RFID tag as shown in FIG. 9.

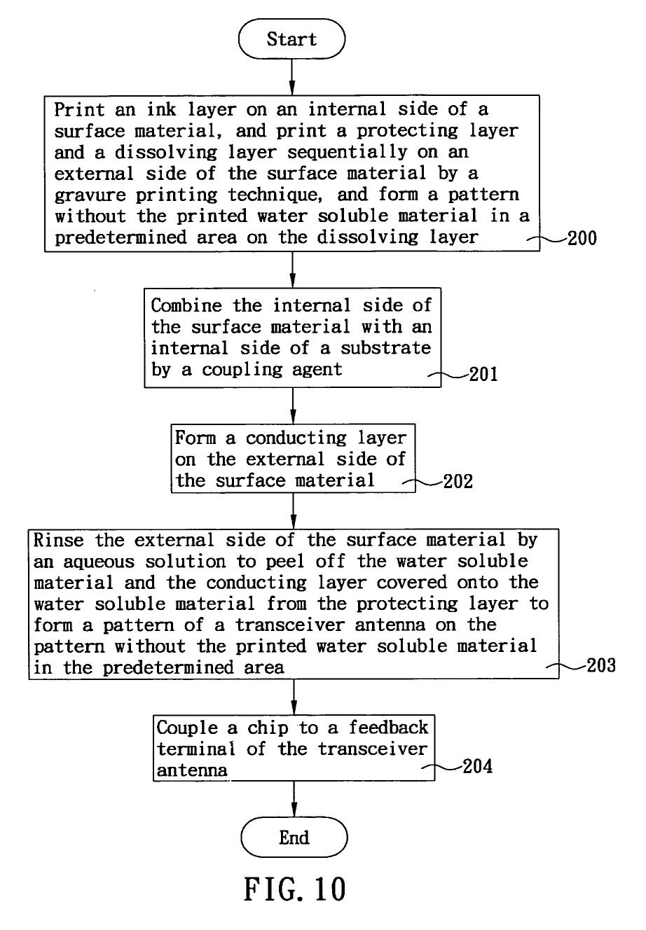

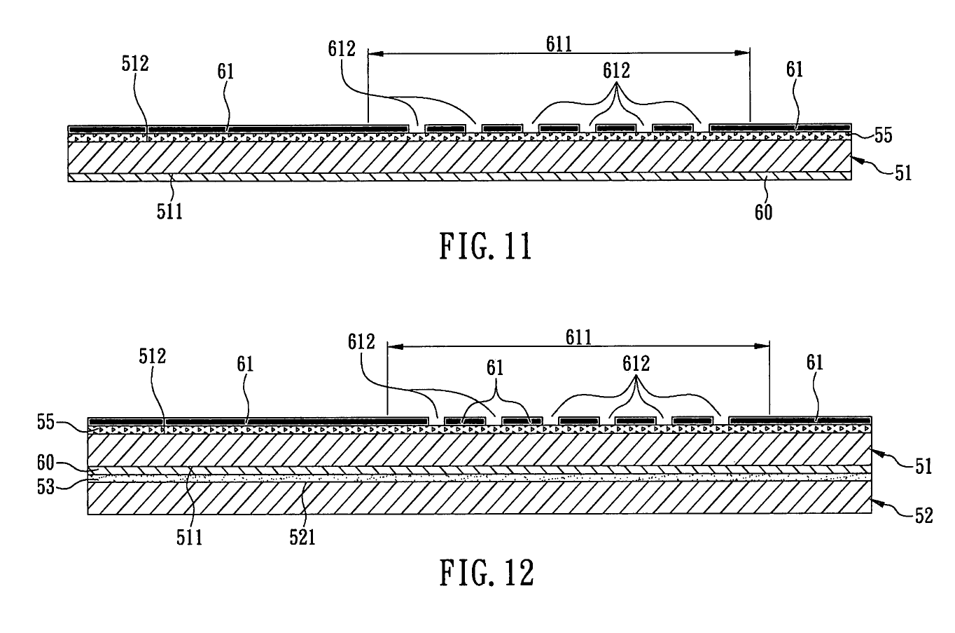

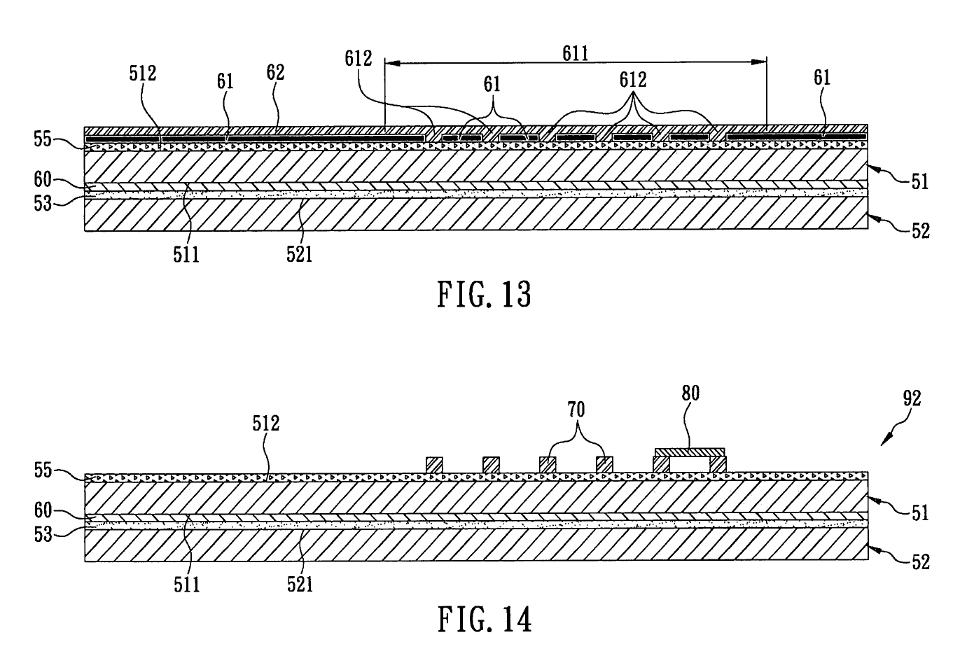

To expedite and simplify the manufacturing process of the packaging material, the inventor of the present invention provides a further embodiment of the method that manufactures the RFID tag on an external side 512 of the surface material 51 as shown in FIG. 10, and the method comprises the steps of:
Step (200): printing an ink layer 60 on an internal side 511 of the surface material 51 by a gravure printing technique to form a decorative pattern (including various decorative, descriptive or advertising texts, patterns or images) as shown in FIG. 11, and printing a protecting layer 55 (such as an anchor coating agent for electroplating) on an external side 512 of the surface material 51, and printing a dissolving layer 61 composed of water soluble material on the protecting layer 55 and forming a pattern 612 without the printed water soluble material in a predetermined area 611 of the dissolving layer 61;
Step (201): combining the internal side 511 of the surface material 51 with the internal side 521 of the substrate 52 by a coupling agent 53 as shown in FIG. 12;
Step (202): forming a conducting layer 62 on the external side 512 of the surface material 51 (which is the dissolving layer 61 and a surface of the predetermined area 611) by coating, sputtering or evaporation as shown in FIG. 13, and it is noteworthy to point out that the aforementioned protecting layer 55 has a heat-resisting temperature higher than the heat-resisting temperature of the surface material 51, and the protecting layer 55 is coated on the surface material 51 for protecting the surface material 51 and preventing the surface material 51 from being deteriorated by the high temperature produced during the sputtering or evaporation process.
Step (203): rinsing the external side 512 of the surface material 51 by an aqueous solution after forming the conducting layer 62 on the external side 512 of the surface material 51 to permeate the aqueous solution into the dissolving layer 61 and dissolve the water soluble material, and peel off the water soluble material and the conducting layer 62 covered onto the water soluble material from the protecting layer 55, such that the conducting layer 62 covered onto a pattern 612 without the printed water soluble material in the predetermined area 611 constitutes a pattern required by a transceiver antenna 70 as shown in FIG. 14; and
Step (204): coupling a chip 80 to a feedback terminal of the transceiver antenna 70 to form a RFID tag on an external side 512 of the surface material 51, so as to produce a packaging material 92 with a printed decorative pattern and a RFID tag as shown in FIG. 14

While the invention has been described by means of specific embodiments, numerous modifications and variations could be made thereto by those skilled in the art without departing from the scope and spirit of the invention set forth in the claims. For example, the thickness of the surface material or the substrate can be modified, or the functional material or the protecting layer can be added to change the structural arrangement of the packaging material or the sequence of the procedure, or the ink layer having the decorative pattern printed on the surface material can be omitted. As long as the packaging material with a RFID tag in accordance with the present invention can be made, the method and the product are intended to be covered by the scope of the present invention.

What is claimed is:

1. A method of manufacturing a radio frequency identification (RFID) tag on a packaging material, comprising the steps of:
printing a protecting layer on an internal side of a surface material by a gravure printing technique, a dissolving layer composed of a water soluble material on the protecting layer, and a pattern without the printed water soluble material in a predetermined area of the dissolving layer;
forming a conducting layer on a surface of the dissolving layer and the predetermined area;
rinsing the internal side of the surface material by an aqueous solution to peel off the protecting layer from the water soluble material and the conducting layer coated on the water soluble material, and the conducting layer coated on the pattern without the printed water soluble material in the predetermined area to constitute a pattern of a transceiver antenna;
coupling a chip to a feedback terminal of the transceiver antenna to form the RFID tag on the internal side of the surface material; and
combining an internal side of the surface material with an internal side of a substrate by a coupling agent to form a packaging material with the RFID tag.

2. The method of claim 1, wherein the protecting layer is made of a material having a heat-resisting temperature higher than the heat-resisting temperature of the surface material.

3. The method of claim 2, wherein the internal side of the surface material further comprises an ink layer on which the protecting layer is printed.

4. The method of claim 3, wherein the protecting layer is made of a material having a heat-resisting temperature higher than the heat-resisting temperature of the ink layer.

5. The method of claim 1, wherein the internal side of the substrate further comprises a functional material, and the coupling agent is provided for combining an internal side of the surface material with an internal side of the functional material.

6. The method of claim 2, wherein the internal side of the substrate further comprises a functional material, and the coupling agent is provided for combining an internal side of the surface material with an internal side of the functional material.

7. The method of claim 3, wherein the internal side of the substrate further comprises a functional material, and the coupling agent is provided for combining an internal side of the surface material with an internal side of the functional material.

8. The method of claim 4, wherein the internal side of the substrate further comprises a functional material, and the coupling agent is provided for combining an internal side of the surface material with an internal side of the functional material.

9. The method of claim 5, wherein the functional material is a thin film made of a lylon material or another plastic material.

10. The method of claim 6, wherein the functional material is a thin film made of a lylon material or another plastic material.

11. The method of claim 7, wherein the functional material is a thin film made of a lylon material or another plastic material.

12. The method of claim 8, wherein the functional material is a thin film made of a lylon material or another plastic material.

13. The method of claim 9, wherein the surface material is a thin film made of a plastic material including OPP or PET.

14. The method of claim 10, wherein the surface material is a thin film made of a plastic material including OPP or PET.

15. The method of claim 11, wherein the surface material is a thin film made of a plastic material including OPP or PET.

16. The method of claim 12, wherein the surface material is a thin film made of a plastic material including OPP or PET.

17. The method of claim 13, wherein the substrate is a thin film made of a plastic material including PE or PP.

18. The method of claim 14, wherein the substrate is a thin film made of a plastic material including PE or PP.

19. The method of claim 15, wherein the substrate is a thin film made of a plastic material including PE or PP.

20. The method of claim 16, wherein the substrate is a thin film made of a plastic material including PE or PP.

21. A method of manufacturing a radio frequency identification (RFID) tag on a packaging material, comprising the steps of:
printing a protecting layer on an external side of a surface material by a gravure printing technique, and printing a dissolving layer composed of a water soluble material on the protecting layer, and printing a pattern in a predetermined area of the dissolving layer without the water soluble material;
combining an internal side of the surface material with an internal side of a substrate by a coupling agent;
forming a conducting layer on the dissolving layer and a surface of the predetermined area;
rinsing the external side of the surface material by an aqueous solution to peel off the protecting layer from the conducting layer of the water soluble material and the conducting layer coated on the pattern without the printed water soluble material in the predetermined area to constitute a pattern of a transceiver antenna; and
coupling a chip to a feedback terminal of the transceiver antenna to form the RFID on the surface material to manufacture the packaging material with the RFID.

22. The method of claim 21, wherein the protecting layer is made of a material having a heat-resisting temperature higher than the heat-resisting temperature of the surface material.

23. The method of claim 22, wherein the internal side of the surface material further comprises an ink layer on which the protecting layer is printed.

24. The method of claim 23, wherein the protecting layer is made of a material having a heat-resisting temperature higher than the heat-resisting temperature of the ink layer.

25. The method of claim 21, wherein the internal side of the substrate further comprises a functional material, and the coupling agent combines an internal side of the surface material with an internal side of the functional material.

26. The method of claim 22, wherein the internal side of the substrate further comprises a functional material, and the coupling agent combines an internal side of the surface material with an internal side of the functional material.

27. The method of claim 23, wherein the internal side of the substrate further comprises a functional material, and the coupling agent combines an internal side of the surface material with an internal side of the functional material.

28. The method of claim 24, wherein the internal side of the substrate further comprises a functional material, and the coupling agent combines an internal side of the surface material with an internal side of the functional material.

29. The method of claim 25, wherein the functional material is a thin film made of a lylon material or another plastic material.

30. The method of claim 26, wherein the functional material is a thin film made of a lylon material or another plastic material.

31. The method of claim 27, wherein the functional material is a thin film made of a lylon material or another plastic material.

32. The method of claim 28, wherein the functional material is a thin film made of a lylon material or another plastic material.

33. The method of claim 29, wherein the surface material is a thin film made of a plastic material including OPP or PET.

34. The method of claim 30, wherein the surface material is a thin film made of a plastic material including OPP or PET.

35. The method of claim 31, wherein the surface material is a thin film made of a plastic material including OPP or PET.

36. The method of claim 32, wherein the surface material is a thin film made of a plastic material including OPP or PET.

37. The method of claim 33, wherein the substrate is a thin film made of a plastic material including PE or PP.

38. The method of claim 34, wherein the substrate is a thin film made of a plastic material including PE or PP.

39. The method of claim 35, wherein the substrate is a thin film made of a plastic material including PE or PP.

40. The method of claim 36, wherein the substrate is a thin film made of a plastic material including PE or PP.

41. A packaging material with a RFID tag, comprising:
a surface material;
a protecting layer, printed on an internal side of the surface material:
a conducting layer, formed on the protecting layer to constitute a pattern of a transceiver antenna;
a chip, coupled to a feedback terminal of the transceiver antenna to form the RFID tag;
a substrate; and
a coupling agent, for combining the internal side of the surface material with an internal side of the substrate.

42. The packaging material of claim 41, wherein the protecting layer is made of a material having a heat-resisting temperature higher than the heat-resisting temperature of the surface material.

43. The packaging material of claim 42, wherein the internal side of the surface material further comprises an ink layer on which the protecting layer is printed.

44. The packaging material of claim 43, wherein the protecting layer is made of a material having a heat-resisting temperature higher than the heat-resisting temperature of the surface material.

45. The packaging material of claim 41, wherein the internal side of the substrate further comprises a functional material, and the coupling agent combines the internal side of the surface material with an internal side of the functional material.

46. The packaging material of claim 42, wherein the internal side of the substrate further comprises a functional material, and the coupling agent combines the internal side of the surface material with an internal side of the functional material.

47. The packaging material of claim 43, wherein the internal side of the substrate further comprises a functional material, and the coupling agent combines the internal side of the surface material with an internal side of the functional material.

48. The packaging material of claim 44, wherein the internal side of the substrate further comprises a functional material, and the coupling agent combines the internal side of the surface material with an internal side of the functional material.

49. The packaging material of claim 45, wherein the functional material is a thin film made of a lylon material or another plastic material.

50. The packaging material of claim 46, wherein the functional material is a thin film made of a lylon material or another plastic material.

51. The packaging material of claim 47, wherein the functional material is a thin film made of a lylon material or another plastic material.

52. The packaging material of claim 48, wherein the functional material is a thin film made of a lylon material or another plastic material.

53. The packaging material of claim 49, wherein the surface material is a thin film made of a plastic material including OPP or PET.

54. The packaging material of claim 50, wherein the surface material is a thin film made of a plastic material including OPP or PET.

55. The packaging material of claim 5 1, wherein the surface material is a thin film made of a plastic material including OPP or PET.

56. The packaging material of claim 52, wherein the surface material is a thin film made of a plastic material including OPP or PET.

57. The packaging material of claim 53, wherein the substrate is a thin film made of a plastic material including PE or PP.

58. The packaging material of claim 54, wherein the substrate is a thin film made of a plastic material including PE or PP.

59. The packaging material of claim 55, wherein the substrate is a thin film made of a plastic material including PE or PP.

60. The packaging material of claim 56, wherein the substrate is a thin film made of a plastic material including PE or PP.

61. A packaging material with a radio frequency identification (RFID) tag, comprising:
a surface material;
a protecting layer, printed on an external side of the surface material;
a conducting layer, formed on the protecting layer to constitute a pattern of a transceiver antenna;
a chip, coupled to a feedback terminal of the transceiver antenna to form the RFID tag;
a substrate; and
a coupling agent, for combining an internal side of the surface material with an internal side of the substrate.

62. The packaging material of claim 61, wherein the protecting layer is made of a material having a heat-resisting temperature higher than the heat-resisting temperature of the surface material.

63. The packaging material of claim 62, wherein the internal side of the surface material further comprises an ink layer on which the protecting layer is printed.

64. The packaging material of claim 63, wherein the protecting layer is made of a material having a heat-resisting temperature higher than the heat-resisting temperature of the ink layer.

65. The packaging material of claim 61, wherein the internal side of the substrate further comprises a functional material, and the coupling agent combines the internal side of the surface material with an internal side of the functional material.

66. The packaging material of claim 62, wherein the internal side of the substrate further comprises a functional material, and the coupling agent combines the internal side of the surface material with an internal side of the functional material.

67. The packaging material of claim 63, wherein the internal side of the substrate further comprises a functional material, and the coupling agent combines the internal side of the surface material with an internal side of the functional material.

68. The packaging material of claim 64, wherein the internal side of the substrate further comprises a functional material, and the coupling agent combines the internal side of the surface material with an internal side of the functional material.

69. The packaging material of claim 65, wherein the functional material is a thin film made of a lylon material or another plastic material.

70. The packaging material of claim 66, wherein the functional material is a thin film made of a lylon material or another plastic material.

71. The packaging material of claim 67, wherein the functional material is a thin film made of a lylon material or another plastic material.

72. The packaging material of claim 68, wherein the functional material is a thin film made of a lylon material or another plastic material.

73. The packaging material of claim 69, wherein the surface material is a thin film made of a plastic material including OPP or PET.

74. The packaging material of claim 70, wherein the surface material is a thin film made of a plastic material including OPP or PET.

75. The packaging material of claim 71, wherein the surface material is a thin film made of a plastic material including OPP or PET.

76. The packaging material of claim 72, wherein the surface material is a thin film made of a plastic material including OPP or PET.

77. The packaging material of claim 73, wherein the substrate is a thin film made of a plastic material including PE or PP.

78. The packaging material of claim 74, wherein the substrate is a thin film made of a plastic material including PE or PP.

79. The packaging material of claim 75, wherein the substrate is a thin film made of a plastic material including PE or PP.

80. The packaging material of claim 76, wherein the substrate is a thin film made of a plastic material including PE or PP.
